(19) United States
(12) Patent Application Publication
(10) Pub. No.: US 2007/0174210 A1
(43) Pub. Date: Jul. 26, 2007

(54) Method and system for issuing convertible preferred securities

(76) Inventors: Jeffrey J. Zajkowski, Short Hills, NJ (US); Gautam Sareen, New York, NY (US)

Correspondence Address: MILBANK, TWEED, HADLEY & MCCLOY, 1 CHASE MANHATTAN PLAZA, NEW YORK, NY, 10005-1413, US

(21) Appl. No.: 11/337,335

(22) Filed: Jan. 23, 2006

(51) Int. Cl. G06Q 40/00

(52) U.S. Cl. 705/36 R

(57) ABSTRACT

A convertible security issued by a financial institution. The security comprises a conversion price, and a provision that allows call of the convertible security only after a predetermined period. The security also comprises a provision that allows conversion of the convertible security if a trading price of shares of common stock of the financial institution is greater than the conversion price or some other level. The security also comprises a provision that allows call or conversion of the convertible security only after approval by a regulatory agency.

The invention relates to the field of financial instruments, and more specifically to the field of convertible financial instruments.

### BACKGROUND

For various reasons, certain regulated industries, such as the banking industry, have not been able to effectively take full advantage of the convertible securities market. What is needed are systems and methods that will allow those regulated industries to take better advantage of the convertible securities market.

The preceding description is not to be construed as an admission that any of the description is prior art relative to the present invention.

### SUMMARY OF THE INVENTION

The various aspects of the embodiments of the inventions provide a convertible security issued by a financial institution. The security comprises a conversion price, and a provision that allows call of the convertible security only after a predetermined period. The security also comprises a provision that allows conversion of the convertible security if a trading price of shares of common stock of the financial institution is greater than the conversion price. The security also comprises a provision that allows call or conversion of the convertible security only after approval by a regulatory agency.

In another aspect the convertible security further comprises a provision that allows the financial institution to call the convertible security only after the predetermined time. In another aspect the convertible security further comprises a provision that allows a holder of the convertible security to convert the convertible security to shares of common stock of the financial institution. In another aspect, the provision that allows call or conversion of the convertible security only after approval by a regulatory agency further comprises a provision that allows the financial institution to call the convertible security only after approval of the call by the regulatory agency. In another aspect, the provision that allows call or conversion of the convertible security only after approval by a regulatory agency further comprises a provision that allows a holder of the convertible security to convert the convertible security only after approval by the regulatory agency. In another aspect the convertible security further comprises a conversion ratio that determines the number of shares of common stock of the financial institution received in exchange for the convertible security. In another aspect, the regulatory agency is the Federal Reserve. In another aspect, the regulatory agency is the Office of Thrift Supervision. In another aspect, the convertible security is perpetual. In another aspect, the convertible security is convertible preferred stock. In another aspect, the predetermined period is about five years. In another aspect, the convertible security is non-cumulative. In another aspect, the convertible security is cumulative. In another aspect the convertible security further comprises a provision that provides a value equal to a percentage of a difference between a conversion value and the conversion price, divided by a sale price of common stock of the financial institution common stock, wherein the conversion value is a product of a conversion ratio and the sale price of common stock of the financial institution common stock. In another aspect the convertible security further comprises a provision that provides cash upon conversion or call. In another aspect the convertible security further comprises a provision that provides net shares upon conversion or call. In another aspect the convertible security further comprises a provision that provides a combination of cash and shares upon conversion or call. In another aspect, the convertible security is a Rule 144A offering. In another aspect, the convertible security is a registered offering. In another aspect, the provision that allows conversion of the convertible security if a trading price of shares of common stock of the financial institution is greater than the conversion price further comprises a requirement that the last reported sale price of common stock of the financial institution for at least 20 trading days during a period of 30 consecutive trading days be greater than the conversion price. In another aspect, the provision that allows call or conversion of the convertible security only after approval by a regulatory agency further comprises a non-convertible period if approval by the regulatory agency is denied, after which a holder of the convertible security may request conversion. In another aspect, the provision that allows call or conversion of the convertible security only after approval by a regulatory agency further comprises a non-callable period if approval by the regulatory agency is denied, after which the financial institution may call the convertible security.

Other various aspects of the embodiments of the inventions provide a system and method for calling a convertible security that is issued by a financial institution. The system and method comprise determining whether a predetermined time period has expired, and determining whether the financial institution has called the convertible security. The system and method further comprise determining whether a regulatory agency has approved the call of the convertible security.

In another aspect the system and method further comprise responsive to determining whether a regulatory agency has approved the call of the convertible security, determining whether a holder of the convertible security accepts the call, or elects to convert the convertible security. In another aspect the system and method further comprise responsive to determining whether a regulatory agency has approved the call of the convertible security, establishing a non-callable period after which the financial institution may call the convertible security. In another aspect the system and method further comprise providing cash upon call. In another aspect the system and method further comprise providing net shares upon call.

Other various aspects of the embodiments of the inventions provide a system and method for converting a convertible security with a conversion price that is issued by a financial institution. The system and method comprise determining whether a holder of the convertible security requests conversion and determining whether a trading price of shares of common stock of the financial institution is greater than the conversion price. The system and method further comprise determining whether a regulatory agency has approved a conversion of the convertible security for shares of the common stock.

In another aspect the system and method further comprise responsive to determining whether a regulatory agency has approved a conversion of the convertible security for shares of the common stock, converting the convertible security for shares of the common stock. In another aspect the system and method further comprise responsive to determining whether a regulatory agency has approved a conversion of the convertible security for shares of the common stock, establishing a non-convertible period after which a holder may request conversion. In another aspect the system and method further comprise providing cash upon conversion. In another aspect the system and method further comprise providing net shares upon conversion. In another aspect the system and method further comprise providing a combination of cash and shares upon conversion.

Other various aspects of the embodiments of the inventions provide a system and method for administering a convertible security with a conversion price that is issued by a financial institution. The system and method comprise determining whether a predetermined time period has expired and determining whether a trading price of shares of common stock of the financial institution is greater than the conversion price. The system and method further comprise determining whether a regulatory agency has approved conversion or call of the convertible security.

In another aspect the system and method further comprise determining whether the financial institution has called the convertible security. In another aspect the system and method further comprise determining whether a holder of the convertible security requests conversion of the convertible security. In another aspect the system and method further comprise responsive to determining whether a regulatory agency has approved conversion or call of the convertible security, determining whether a holder of the convertible security accepts call of the convertible security, or elects to convert the convertible security. In another aspect the system and method further comprise responsive to determining whether a regulatory agency has approved conversion or call of the convertible security, establishing a non-callable period after which the financial institution may call the convertible security. In another aspect the system and method further comprise responsive to determining whether a regulatory agency has approved conversion or call of the convertible security, establishing a non-conversion period after which a holder of the convertible security may request conversion. In another aspect the system and method further comprise providing cash upon conversion or call. In another aspect the system and method further comprise providing net shares upon conversion or call. In another aspect the system and method further comprise providing a combination of cash and shares upon conversion or call. In another aspect the system and method further comprise responsive to determining whether a regulatory agency has approved conversion or call of the convertible security, converting the convertible security for shares of common stock of the financial institution. In another aspect the system and method further comprise responsive to determining whether a regulatory agency has approved conversion or call of the convertible security, calling the convertible security.

The foregoing specific aspects are illustrative of those which can be achieved and are not intended to be exhaustive or limiting of the possible advantages that can be realized. Thus, the objects and advantages will be apparent from the description herein or can be learned from practicing the invention, both as embodied herein or as modified in view of any variations which may be apparent to those skilled in the art. Accordingly the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates a system according to an embodiment;

FIG. 2 illustrates steps in a method according to an embodiment; and

FIG. 3 illustrates steps in a method according to an embodiment.

It is understood that the drawings are for illustration only and are not limiting.

### DETAILED DESCRIPTION OF THE DRAWINGS

Various embodiments of the invention are described below. In particular, a financial institution, such as a bank, issues a perpetual convertible security, such as convertible preferred stock. The convertible security includes a conversion ratio to indicate how many shares of issuer common stock a holder of the convertible security will receive upon exchange or conversion of the convertible security. The conversion ratio may be adjusted for a number of reasons.

The convertible security also includes a conversion price. Investors or holders of the convertible security may surrender or convert the convertible security if the issuer common stock price is above the conversion price or some other level. Upon conversion, a conversion value is calculated by multiplying the conversion ratio and the last reported sale price of the issuer common stock for ten consecutive trading days. Upon conversion, the holder or investor receives cash equal to the lesser of an issue price and the conversion value. To the extent that the conversion value exceeds the issue price, the holder or investor also receives a number of shares equal to the sum of, for each day of the 10-day cash settlement averaging period, (a) 10% of the difference between the conversion value and the issue price, divided by (b) the last reported sale price of the issuer common stock for such day.

A regulatory agency, such as the Federal Reserve, or the Office of Thrift Supervision, must approve any investor or holder request for conversion, and if the regulatory agency disallows a conversion, the convertible security becomes non-convertible for a period of time, such as 3 months. After the non-convertible period passes, the investor or holder may again request conversion. The convertible security is not callable by the issuer during an initial no-call period of time, such as 5 years. After the initial no-call period expires, the issuer may call the convertible security. A regulatory agency, such as the Federal Reserve or the Office of Thrift Supervision, must approve the issuer call of the convertible security, and if the regulatory agency disallows the call, the convertible security becomes non-callable for a period of time, such as 3 months. After the non-callable period passes, the issuer may again call the convertible security, with the consent of the regulatory agency.

The investor or holder is entitled to receive non-cumulative cash dividends on the convertible security at a predetermined rate, payable quarterly in arrears. Dividends on the convertible security accrue from the date of original issue. The issuer may defer dividends.

In general, investors or holders of the convertible security are likely to want to convert when the stock price is in the money (i.e., the stock price is above the conversion price or some other level). A rise in the underlying stock price signals a growing and healthy financial institution, and the regulatory agency is more likely to approve the request for conversion in these circumstances than when the underlying stock price has declined. Therefore, investors understand the risks, and are comfortable with the risk that they may not be able to convert the convertible security in certain situations.

An Example System

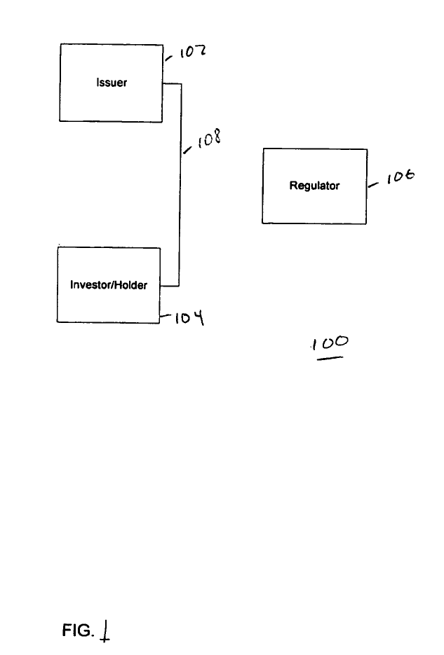

Referring to FIG. 1, an example system 100 according to an embodiment of the invention includes an issuer 102 of a financial instrument, investors or holders 104 of the financial instruments, and a regulatory agency 106. A network 108 connects issuer 102 and investor/holders 104. Issuer 102 and investors/holders 104 have various computer systems that include central processors for executing program code, memory (RAM, ROM, PROM, EPROM etc.), fixed and removable code storage media for storing software program code (hard drive, floppy drive, CD, DVD, memory stick, optical drive, etc.), input and output devices (keyboards, displays, pointing devices, scanners, printers, etc.), and interface devices (Ethernet cards, WiFi cards, modems, etc.). Issuer 102 and investors/holders 104 use network 108 (internet, intranet, extranet, the Internet, PSTN, etc.) to communicate electronically. Computer executable software program code stored in computer-readable fixed and removable code storage media may be transmitted as an information signal from one system to another. Although not illustrated, in one embodiment regulator 106 is electronically connected to network 108.

Issuer 102 is regulated by regulatory agency 106, and in one embodiment issuer 102 is a bank, and regulator 106 is the Federal Reserve. In another embodiment, issuer 102 is a savings bank or a savings and loan, and regulator 106 is the Office of Thrift Supervision.

An Example Method

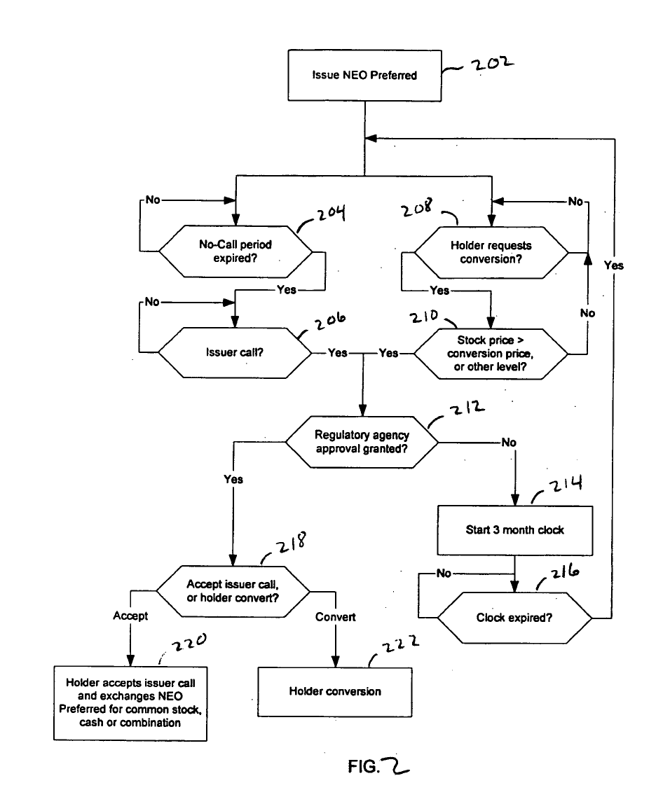

Referring to FIG. 2, at step 202, issuer 102 issues a convertible security. The security has a conversion price and number of provisions discussed elsewhere.

At step 204, system 100 determines whether an initial predetermined no-call period has expired. During the no-call period, issuer 102 is not allowed to call the convertible security. In one embodiment, this no-call period is 5 years. If the no-call period has not expired, system 100 loops to step 204.

If at step 204, system 100 determines that the no-call period has expired, then at step 206, system 100 determines whether issuer 102 has called the convertible security. If not, system 100 loops to step 206.

After issuer 102 issues the convertible security at step 202, in a set of steps independent of steps 204 and 206, system 100 also determines at step 208 whether holder 104 requests conversion of the convertible security. If not, system 100 loops to step 208. If at step 108 system 100 determines that holder 104 does request conversion, then at step 210 system 100 determines whether the common stock price of issuer 102 is or has been greater than the conversion price or some other level. If the common stock price of issuer 102 has not been greater than the conversion price or some other level, then system 100 loops to step 208. In one embodiment, the closing common stock price of issuer 102 must be greater than or equal to the conversion price for 20 trading days of the 30 consecutive trading days ending on the last trading day before the conversion date.

If at step 206 system 100 determines that issuer 102 has called the convertible security, or at step 210 system 100 determines that the common stock price of issuer 102 is or has been greater than the conversion price or some other level, then at step 212 system 100 determines whether regulatory agency 106 has approved the conversion or call.

If at step 212 system 100 determines that regulatory agency 106 has not approved the conversion or call, then at steps 214, 216 system 100 starts a 3 month clock, and after the 3 month clock expires loops to steps 204 and 208.

If at step 212 system 100 determines that regulatory agency 106 has approved the conversion or call, then at step 218 system 100 determines whether holder 104 accepts the issuer call, or whether the holder converts. If holder 104 accepts issuer 102's call, then at step 220, holder 104 surrenders the convertible security and receives common stock of issuer 102, or receives cash, or receives a combination of common stock and cash.

If holder 104 converts, then at step 222 they receive cash, shares and/or a combination in settlement.

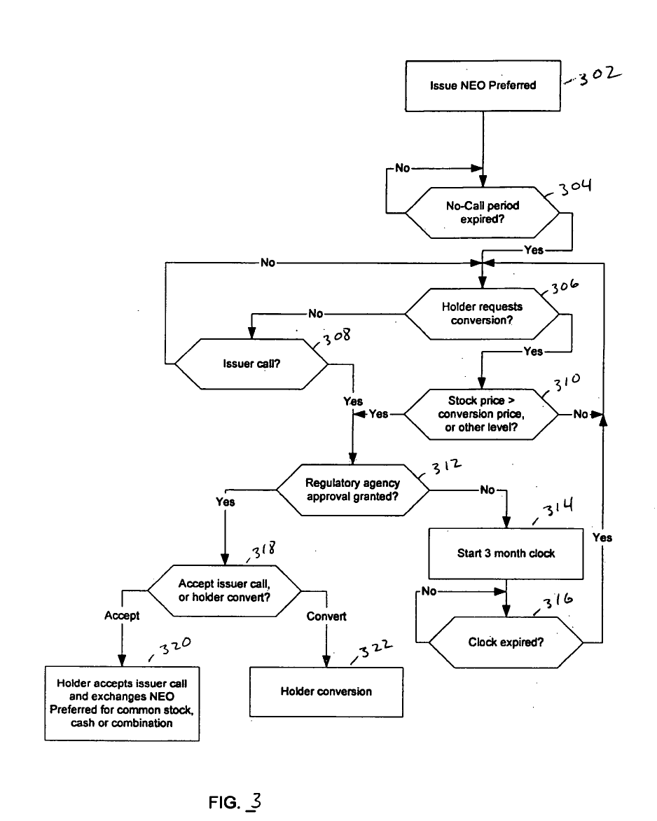

Referring to FIG. 3, another embodiment begins at step 302 when issuer 102 issues a convertible security. The security has a conversion price and number of provisions discussed elsewhere.

At step 304, system 100 determines whether an initial predetermined no-call period has expired. During the no-call period, issuer 102 is not allowed to call the convertible security. In one embodiment, this no-call period is 5 years. If the no-call period has not expired, system 100 loops to step 304.

If at step 304, system 100 determines that the no-call period has expired, then at step 306, system 100 determines whether holder 104 has requested conversion of the convertible security. If not, at step 308, system 100 determines whether issuer 102 has called the convertible security. If not, system 100 loops to step 306.

If at step 306 system 100 determines that holder 104 requests conversion of the convertible security, then at step 310, system 100 determines whether the common stock price of issuer 102 is or has been greater than the conversion price or some other level. If the common stock price of issuer 102 has not been greater than the conversion price or some other level, then system 100 loops to step 306. In one embodiment, the closing common stock price of issuer 102 must be greater than or equal to the conversion price for 20 trading days of the 30 consecutive trading days ending on the last trading day before the conversion date.

If at step 308 system 100 determines that issuer 102 calls the convertible security, or at step 310 system 100 determines that the stock price is greater than the conversion price or some other level, then at step 312, system 100 determines whether regulatory agency 106 has approved the conversion or call.

If at step 312 system 100 determines that regulatory agency 106 has not approved the conversion or call, then at steps 314, 316 system 100 starts a 3 month clock, and after the 3 month clock expires loops to step 306.

If at step 312 system 100 determines that regulatory agency 106 has approved the conversion or call, then at step 318 system 100 determines whether holder 104 accepts the issuer call, or whether the holder converts. If holder 104 accepts issuer 102's call, then at step 320, holder 104 surrenders the convertible security and receives common stock of issuer 102, or receives cash, or receives a combination of common stock and cash.

If holder 104 converts, then at step 322 they receive cash, shares and/or a combination in settlement.

The convertible security includes one or more of the following provisions: a provision that allows conversion or call of the convertible security after a pre-determined no-call period; a provision that allows conversion of the convertible security if a trading price of shares of common stock of the financial institution is greater than the conversion price; a provision that allows conversion or call of the convertible security only after approval by a regulatory agency; a provision that allows the issuer of the convertible security to call the convertible security only after the predetermined time; a provision that allows the holder of the convertible security to request conversion of the convertible security; and a conversion ratio that determines the number of shares of common stock received in exchange for the convertible security.

In one embodiment the convertible security is perpetual. In one embodiment, the convertible security is convertible preferred stock. In one embodiment the no-call period is 5 years. In one embodiment the convertible security is cumulative, and in another embodiment the convertible security is non-cumulative.

In one embodiment the holder is paid cash upon conversion or call. In one embodiment, the holder receives net shares upon conversion or call. In one embodiment, the holder receives shares and cash upon conversion or call.

In one embodiment the convertible security is offered under a Rule 144A offering. In one embodiment the convertible security is a registered offering. In one embodiment the convertible security is a private offering.

In one embodiment if the regulatory agency declines to approve conversion, the holder may again request conversion of the convertible security after a waiting period with regulatory agency approval. In one embodiment the waiting period is about 3 months.

In one embodiment if the regulatory agency declines to approve call, the issuer may again call the convertible security after a waiting period with regulatory agency approval. In one embodiment the waiting period is about 3 months.

In one embodiment the issuer is a financial institution, such as a bank, a savings bank, or a savings and loan. In one embodiment the regulatory agency is the Federal Reserve or the Office of Thrift Supervision.

Although illustrative embodiments have been described herein in detail, it should be noted and will be appreciated by those skilled in the art that numerous variations may be made within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A convertible security issued by a financial institution, the security comprising:
a conversion price;
a provision that allows call of the convertible security only after a predetermined period;
a provision that allows conversion of the convertible security if a trading price of shares of common stock of the financial institution is greater than the conversion price; and
a provision that allows call or conversion of the convertible security only after approval by a regulatory agency.

2. A convertible security according to claim 1, further comprising a provision that allows the financial institution to call the convertible security only after the predetermined time.

3. A convertible security according to claim 1, further comprising a provision that allows a holder of the convertible security to convert the convertible security to shares of common stock of the financial institution.

4. A convertible security according to claim 1, wherein the provision that allows call or conversion of the convertible security only after approval by a regulatory agency further comprises a provision that allows the financial institution to call the convertible security only after approval of the call by the regulatory agency.

5. A convertible security according to claim 1, wherein the provision that allows call or conversion of the convertible security only after approval by a regulatory agency further comprises a provision that allows a holder of the convertible security to convert the convertible security only after approval by the regulatory agency.

6. A convertible security according to claim 1, further comprising a conversion ratio that determines the number of shares of common stock of the financial institution received in exchange for the convertible security.

7. A convertible security according to claim 1, wherein the regulatory agency is the Federal Reserve.

8. A convertible security according to claim 1, wherein the regulatory agency is the Office of Thrift Supervision.

9. A convertible security according to claim 1, wherein the convertible security is perpetual.

10. A convertible security according to claim 1, wherein the convertible security is convertible preferred stock.

11. A convertible security according to claim 1, wherein the predetermined period is about five years.

12. A convertible security according to claim 1, wherein the convertible security is non-cumulative.

13. A convertible security according to claim 1, wherein the convertible security is cumulative.

14. A convertible security according to claim 1, further comprising a provision that provides a value equal to a percentage of a difference between a conversion value and the conversion price, divided by a sale price of common stock of the financial institution common stock, wherein the conversion value is a product of a conversion ratio and the sale price of common stock of the financial institution common stock.

15. A convertible security according to claim 1, further comprising a provision that provides cash upon conversion or call.

16. A convertible security according to claim 1, further comprising a provision that provides net shares upon conversion or call.

17. A convertible security according to claim 1, further comprising a provision that provides a combination of cash and shares upon conversion or call.

18. A convertible security according to claim 1, wherein the convertible security is a Rule 144A offering.

19. A convertible security according to claim 1, wherein the convertible security is a registered offering.

20. A convertible security according to claim 1, wherein the provision that allows conversion of the convertible security if a trading price of shares of common stock of the financial institution is greater than the conversion price further comprises a requirement that the last reported sale price of common stock of the financial institution for at least 20 trading days during a period of 30 consecutive trading days be greater than the conversion price.

21. A convertible security according to claim 1, wherein the provision that allows call or conversion of the convertible security only after approval by a regulatory agency further comprises a non-convertible period if approval by the regulatory agency is denied, after which a holder of the convertible security may request conversion.

22. A convertible security according to claim 1, wherein the provision that allows call or conversion of the convertible security only after approval by a regulatory agency further comprises a non-callable period if approval by the regulatory agency is denied, after which the financial institution may call the convertible security.

23. A method for calling a convertible security that is issued by a financial institution, the method comprising:
determining whether a predetermined time period has expired;
determining whether the financial institution has called the convertible security; and
determining whether a regulatory agency has approved the call of the convertible security.

24. A method according to claim 23, further comprising responsive to determining whether a regulatory agency has approved the call of the convertible security, determining whether a holder of the convertible security accepts the call, or elects to convert the convertible security.

25. A method according to claim 23, further comprising responsive to determining whether a regulatory agency has approved the call of the convertible security, establishing a non-callable period after which the financial institution may call the convertible security.

26. A method according to claim 23, further comprising providing cash upon call.

27. A method according to claim 23, further comprising providing net shares upon call.

28. A method for converting a convertible security with a conversion price that is issued by a financial institution, the method comprising:
determining whether a holder of the convertible security requests conversion;
determining whether a trading price of shares of common stock of the financial institution is greater than the conversion price; and
determining whether a regulatory agency has approved a conversion of the convertible security for shares of the common stock.

29. A method according to claim 28, further comprising responsive to determining whether a regulatory agency has approved a conversion of the convertible security for shares of the common stock, converting the convertible security for shares of the common stock.

30. A method according to claim 28, further comprising responsive to determining whether a regulatory agency has approved a conversion of the convertible security for shares of the common stock, establishing a non-convertible period after which a holder may request conversion.

31. A method according to claim 28, further comprising providing cash upon conversion.

32. A method according to claim 28, further comprising providing net shares upon conversion.

33. A method according to claim 28, further comprising providing a combination of cash and shares upon conversion.

34. A method for administering a convertible security with a conversion price that is issued by a financial institution, the method comprising:
determining whether a predetermined time period has expired;
determining whether a trading price of shares of common stock of the financial institution is greater than the conversion price; and
determining whether a regulatory agency has approved conversion or call of the convertible security.

35. A method according to claim 34, further comprising determining whether the financial institution has called the convertible security.

36. A method according to claim 34, further comprising determining whether a holder of the convertible security requests conversion of the convertible security.

37. A method according to claim 34, further comprising responsive to determining whether a regulatory agency has approved conversion or call of the convertible security, determining whether a holder of the convertible security accepts call of the convertible security, or elects to convert the convertible security.

38. A method according to claim 34, further comprising responsive to determining whether a regulatory agency has approved conversion or call of the convertible security, establishing a non-callable period after which the financial institution may call the convertible security.

39. A method according to claim 34, further comprising responsive to determining whether a regulatory agency has approved conversion or call of the convertible security, establishing a non-conversion period after which a holder of the convertible security may request conversion.

40. A method according to claim 34, further comprising providing cash upon conversion or call.

41. A method according to claim 34, further comprising providing net shares upon conversion or call.

42. A method according to claim 34, further comprising providing a combination of cash and shares upon conversion or call.

43. A method according to claim 34, further comprising responsive to determining whether a regulatory agency has approved conversion or call of the convertible security, converting the convertible security for shares of common stock of the financial institution.

44. A method according to claim 34, further comprising responsive to determining whether a regulatory agency has approved conversion or call of the convertible security, calling the convertible security.

45. A system for calling a convertible security that is issued by a financial institution, the system comprising:
means for determining whether a predetermined time period has expired;
means for determining whether the financial institution has called the convertible security; and
means for determining whether a regulatory agency has approved the call of the convertible security.

46. Computer executable software code transmitted as an information signal, the code for calling a convertible security that is issued by a financial institution, the code comprising:
code to determine whether a predetermined time period has expired;
code to determine whether the financial institution has called the convertible security; and
code to determine whether a regulatory agency has approved the call of the convertible security.

47. A computer-readable medium having computer executable software code stored thereon, the code for calling a convertible security that is issued by a financial institution, the code comprising:
code to determine whether a predetermined time period has expired;
code to determine whether the financial institution has called the convertible security; and
code to determine whether a regulatory agency has approved the call of the convertible security.

48. A programmed computer for calling a convertible security that is issued by a financial institution, comprising:
a memory having at least one region for storing computer executable program code; and
a processor for executing the program code stored in the memory; wherein the program code comprises:
code to determine whether a predetermined time period has expired;
code to determine whether the financial institution has called the convertible security; and
code to determine whether a regulatory agency has approved the call of the convertible security.

49. A system for converting a convertible security with a conversion price that is issued by a financial institution, comprising:
means for determining whether a holder of the convertible security requests conversion;
means for determining whether a trading price of shares of common stock of the financial institution is greater than the conversion price; and
means for determining whether a regulatory agency has approved a conversion of the convertible security for shares of the common stock.

50. Computer executable software code transmitted as an information signal, the code for converting a convertible security with a conversion price that is issued by a financial institution, the code comprising:
code to determine whether a holder of the convertible security requests conversion;
code to determine whether a trading price of shares of common stock of the financial institution is greater than the conversion price; and
code to determine whether a regulatory agency has approved a conversion of the convertible security for shares of the common stock.

51. A computer-readable medium having computer executable software code stored thereon, the code for converting a convertible security with a conversion price that is issued by a financial institution, the code comprising:
code to determine whether a holder of the convertible security requests conversion;
code to determine whether a trading price of shares of common stock of the financial institution is greater than the conversion price; and
code to determine whether a regulatory agency has approved a conversion of the convertible security for shares of the common stock.

52. A programmed computer for converting a convertible security with a conversion price that is issued by a financial institution, comprising:
a memory having at least one region for storing computer executable program code; and
a processor for executing the program code stored in the memory; wherein the program code comprises:
code to determine whether a holder of the convertible security requests conversion;
code to determine whether a trading price of shares of common stock of the financial institution is greater than the conversion price; and
code to determine whether a regulatory agency has approved a conversion of the convertible security for shares of the common stock.

53. A system for administering a convertible security with a conversion price that is issued by a financial institution, comprising:
means for determining whether a predetermined time period has expired;
means for determining whether a trading price of shares of common stock of the financial institution is greater than the conversion price; and
means for determining whether a regulatory agency has approved conversion or call of the convertible security.

54. Computer executable software code transmitted as an information signal, the code for administering a convertible security with a conversion price that is issued by a financial institution, the code comprising:
code to determine whether a predetermined time period has expired;
code to determine whether a trading price of shares of common stock of the financial institution is greater than the conversion price; and
code to determine whether a regulatory agency has approved conversion or call of the convertible security.

55. A computer-readable medium having computer executable software code stored thereon, the code for administering a convertible security with a conversion price that is issued by a financial institution, the code comprising:
code to determine whether a predetermined time period has expired;
code to determine whether a trading price of shares of common stock of the financial institution is greater, than the conversion price; and
code to determine whether a regulatory agency has approved conversion or call of the convertible security.

56. A programmed computer for administering a convertible security with a conversion price that is issued by a financial institution, comprising:
a memory having at least one region for storing computer executable program code; and
a processor for executing the program code stored in the memory; wherein the program code comprises:
code to determine whether a predetermined time period has expired;
code to determine whether a trading price of shares of common stock of the financial institution is greater than the conversion price; and
code to determine whether a regulatory agency has approved conversion or call of the convertible security.
